(19) United States
(12) Patent Application Publication
(10) Pub. No.: US 2015/0229718 A1
(43) Pub. Date: Aug. 13, 2015

(54) PROTOCOL FOR EXCHANGING DATA BETWEEN TWO DEVICES

(71) Applicant: Apple Inc., Cupertino, CA (US)

(72) Inventors: Curtis C. Galloway, Santa Cruz, CA (US); Gregory D. Bolsinga, San Francisco, CA (US); Ingo A. Schurr, Cupertino, CA (US); Kaspar Fischer, San Francisco, CA (US); Marco Primi, San Jose, CA (US); Nathaniel R. Rivard, San Francisco, CA (US); Nils Stefan Daniel Bengtsson, Cupertino, CA (US); Steven Alyari, Los Altos, CA (US)

(21) Appl. No.: 14/292,807

(22) Filed: May 30, 2014

Related U.S. Application Data
(60) Provisional application No. 61/938,474, filed on Feb. 11, 2014.

(51) Int. Cl. H04L 29/08; H04L 29/06

(52) U.S. Cl. CPC H04L 67/1095; H04L 67/06; H04L 67/42

(57) ABSTRACT

Some embodiments provide a protocol for a first device to obtain information about one or more data entities from a second device. In some embodiments, the first device is a client device, while the second device is a server device. In some embodiments, the protocol specifies a request that includes an entity identifying parameter set and a description of the desired information for each entity that the second device identifies based on the entity identifying parameter set. In some embodiments, the protocol specifies a response from the second device includes a set of entities that were identified based on the entity identifying parameter set, and for each entity in the set of entities, a list of responses that includes a set of data values or data objects for each information component set that the first device requested for the identified entities.

### CLAIM OF BENEFIT TO PRIOR APPLICATIONS

This application claims the benefit of U.S. Provisional Patent Application 61/938,474, entitled “Protocol for Exchanging Data between Two Devices”, filed Feb. 11, 2014. U.S. Provisional Patent Application 61/938,474 is incorporated herein by reference.

### BACKGROUND

Devices today exchange data based on protocols that are not configurable to the needs or capabilities of the requesting device. For instance, many protocols provide all client devices that request information about a set of entities from a server device the same information, irrespective of whether the client devices want that information. Also, many protocols require the client devices to operate the latest version of the protocol in order to be able to request the desired information from the server device. Further, existing protocols can often provide large amounts of data to different client devices irrespective of whether any one client device actually needs all of the provided data. Therefore, there is a need in the art for a better protocol for exchanging data between devices.

### BRIEF SUMMARY

Some embodiments of the invention provide a protocol for a first device to obtain information about one or more data entities from a second device. In some embodiments, the first device is a client device, while the second device is a server device. The data entities are entities for which the second device can identify one or more sets of information. For example, the data entities in some embodiments are points of interest (POIs) on a map, for which a server can gather multiple different types of information, e.g., address, photos, weather, reviews, etc.

The protocol of some embodiments specifies (1) the format of the request from the first device and (2) the format of the response from the second device. In some embodiments, the request has two conceptual parts. The first part is an entity identifying parameter set, which the second device is to use to identify one or more data entities that satisfy the information request from the first device. In some embodiments, the entity identifying parameter set is expressed either as a list of entity identifiers or as a. set of search parameters. For instance, in some embodiments, the client either (1) gives the server a list of entity identifiers (e.g., ID numbers) representing entities for which it wants information, and the server returns information about each found entity, or (2) the client requests certain search parameters without knowing the entity identifiers of the entities it wants, and the server performs the search and returns information about entities that match the search parameters.

The second part is a description of the desired information for each entity that the second device identifies based on the entity identifying parameter set. In some embodiments, the second part specifies (1) one or more information sets (called information component sets below) for each identified entity, and (2) for each specified information component set, (i) a maximum number of values to gather, and (ii) a set of filtering: parameters to filter out undesirable values from the gathered number of values.

In some embodiments, the response from the second device includes (1) a set of entities that were identified based on the entity identifying parameter set, and (2) for each entity in the set of entities, a list of responses that includes one or more values for each information component set that the first device requested for the identified entities. The second device in some embodiments may return a null value (or ‘not found’ value or an empty set) for an information component set.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE FIGURES

The novel features of the invention are set forth in the appended claims. However, for purposes of explanation, several embodiments of the invention are set forth in the following figures.

FIG. 1 illustrates an example of the novel protocol of some embodiments.

FIG. 2 illustrates a system that includes the client and server devices of some embodiments of the invention.

FIG. 3 illustrates an example of a display area that presents integrated informational views for POIs on a map.

FIG. 4 illustrates another of a display area that presents integrated informational views for POIs on a map.

FIG. 5 illustrates a map example that has two different POIs, one that in this example only needs static data types, and another that in this example needs both static and dynamic data types.

FIG. 6 illustrates a process that a client device performs in some embodiments when it uses the request protocol of some embodiments.

FIG. 7 illustrates a process that a server performs to process a request from a client.

FIG. 8 illustrates an example request and response according to the protocol of some embodiments of the invention.

FIG. 9 illustrates another example request and response according to the protocol of some embodiments of the invention.

FIG. 10 illustrates yet another example request and response according to the protocol of some embodiments of the invention.

FIG. 11 conceptually illustrates an example of an architecture of a mobile computing device.

FIG. 12 conceptually illustrates another example of an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a protocol for a first device to obtain information about one or more data entities from a second device. The data entities are entities for which the second device can identify one or more sets of information. For example, in some embodiments, the data entities are points of interest (POIs) on a map, for which a server can gather multiple different types of information, e.g., address, photos, weather, reviews, etc.

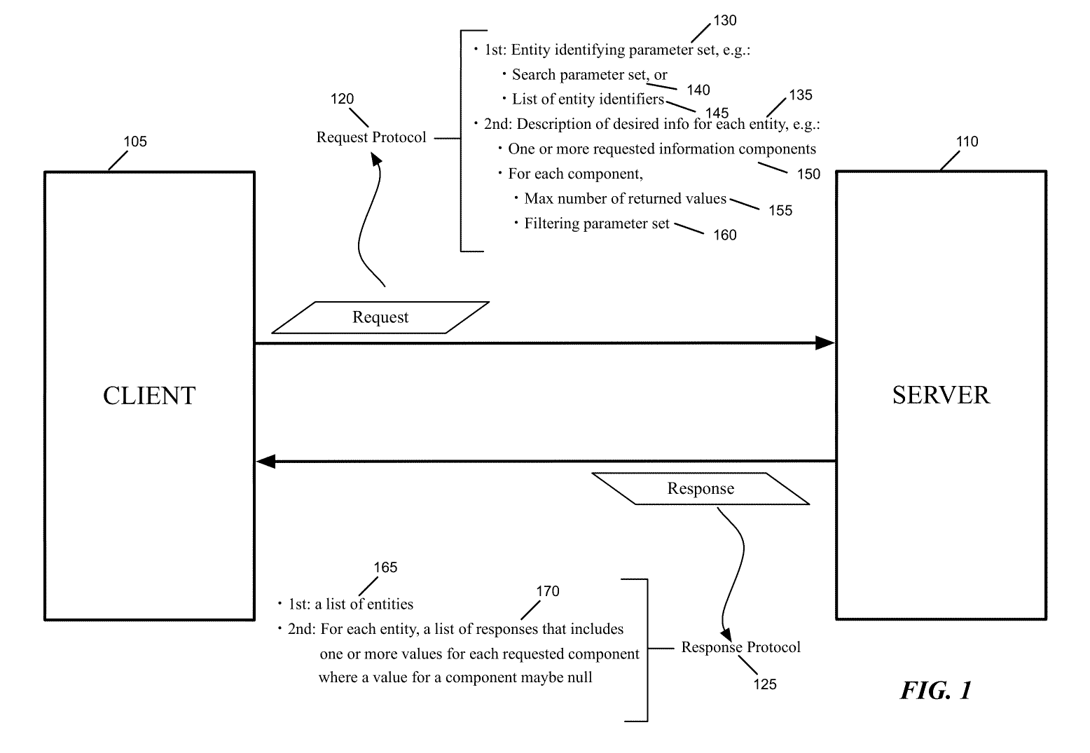

FIG. 1 illustrates an example of the novel protocol of some embodiments. This example is illustrated in the context where the first device is a client device 105 and the second device is a server device 110. As shown in FIG. 1, the protocol of some embodiments includes request-side protocol 120 and response-side protocol 125 that respectively specify the format of the request from the first device and the format of the response from the second device.

In some embodiments, the request has two conceptual parts. The first part is an entity identifying parameter set 130 for the second device to use to identify one or more data entities that satisfy the information request from the first device. As shown in FIG. 1, the entity ID parameter set 130 in some embodiments is expressed either as a set of search parameters 140 or as a list of entity identifiers 145. The second part 135 is a description of the desired information that the first device wants for each entity that the second device identifies based on the entity identifying parameter set. In some embodiments, the second part specifies (1) one or more information sets 150 (called information component sets below) for each identified entity, and (2) for each specified information component set, (i) a maximum number 155 of values to gather, and (ii) a set of filtering parameters 160 to filter out undesirable values from the gathered number of values. In some embodiments, the second part also specifies at least one parameter that requests, for a component type, the overall total number of values that are available for the server 110 to provide to the client 105.

In some embodiments, different requests can have different request types, and different request types having different ID parameter sets 130. For instance, in some embodiments, a search that is based on a lookup of a set of POI identifiers is specified in terms of a list of identifiers 145. Alternatively, a. search for certain entities near a location is specified in some embodiments in terms of a lat/long coordinates (a latitude, a longitude) of a location, a radius about the location and a search string that describes the entities. Another example would be an address lookup that is specified in terms of a string that represents the address.

As shown in FIG. 1, the response 125 from the second device in some embodiments includes (1) a set of entities 165 that were identified based on the entity identifying parameter set, and (2) for each entity in the set of entities, a list of responses 170 that includes one or more values for each information component set that the first device 105 requested for the identified entities. The second device 110 in some embodiments may return a null value (or ‘not found’ value or an empty set) for an information component set. In some embodiments, the second device returns, for one or more component types, the overall total number of data values that the second device can provide to the first device.

As further described below, the response protocol in some embodiments also includes a UI presentation component that allows the server to tell the client the best order to display the returned information, and to give it a hint that certain information should be highlighted or made more prominent. In some embodiment, the UI presentation component is one of the information component sets returned by the server. In some embodiments, the response protocol also includes a section that returns some data that was specific to the request, but is separate from the data returned for the entities. This section in some embodiments includes global response data (e.g., response data that is sent to each request and that does not vary irrespective of the entity identified), such as how long the request took, how accurately the server thought it was able to match the search request.

The protocol of FIG. 1 has several advantages. One advantage is that this protocol does not require the client to know in advance much about the entities for which it is requesting information. Another advantage is that this protocol allows information to be packaged into different component sets that cover different use cases. This protocol allows the client to indicate to the server the information that it needs in the response. Specifically, this protocol allows the client to request particular information components sets and to provide the server with filter values that allow the server to differently filter the data values returned for different information component sets. In this manner, the client does not get a bunch of information component sets that it does not need, and the sizes of responses from the server are efficient as the server only returns the requested data.

The protocol also allows new information component sets to be added by the server at any time without affecting previous clients that do not know about them. In other words, the protocol allows the server to work with different versions of the clients that have different knowledge of the types of information components sets that the server can provide. To process requests that are made pursuant to this protocol, the server can assemble data from one or more sources. The assembled data can be data that remains static or fairly static, or it can be data that changes quite dynamically.

Several examples of requests and responses according to this protocol are provided below in Section III. However, before describing these examples, Section I describes the client-server environment of some embodiments, and a client mapping application that uses the protocol of some embodiments, while Section II describes the client-server operations of some embodiments. Section IV finally describes electronic devices that are used in some embodiments to implement the client and server device.

### I. Client-Server Environment and Operations

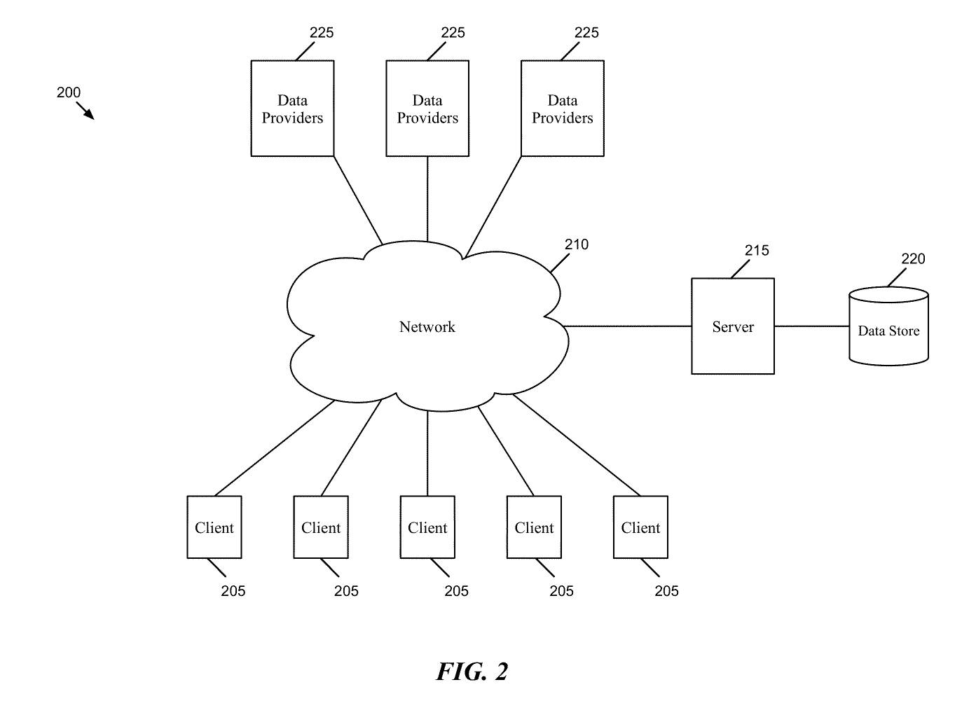

FIG. 2 illustrates a system 200 that includes the client and server devices of some embodiments of the invention. As shown in this figure, the system 200 includes several clients 205, a server 215, one or more server data stores 220, and several data providers 225. The clients, server, and data providers are communicatively coupled through a network 210, which in some embodiments includes several networks, such a local area networks, wide area networks, a network of networks (Internet) and/or cellular telecommunication networks (e.g., 3G networks, 4G-LTE networks, etc.).

The clients are electronic devices, such as mobile devices (e.g., smartphones or tablets) and/or computers (e.g., laptops or desktop computers). Through the network, each client 205 sends information requests to the server 215 by using the request protocol of some embodiments, and the server provides information responses to the clients by using the response protocol of some embodiments. The server is one physical machine in some embodiments, while it is multiple servers executing on one or more physical machines in other embodiments.

To process the information requests from the clients 205, the server 215 in some embodiments examines one or more local server data stores 220 and/or several data providers 225. Specifically, in some embodiments, the server 215 examines the data store(s) 220 to identify one or more data entities that match the search criteria defined by the entity ID parameter set 130 that is part of the request from a client. To identify such entities, the server 215 in some embodiments also interacts with the data providers 225. For instance, in some embodiments, the server provides one or more parts of the entity ID parameter 130 to one or more data providers so that they can identify the matching data entities. In other embodiments, however, the server 215 does not interact with the data providers 225 to identify data entities based on the supplied entity ID parameter set.

For each data entity that the server identifies based on the entity ID parameter set 130, the server 215 retrieves from the data store(s) 220 and/or data providers 225 information that is based on the desired information description 135 in the request from the client. For instance, in some embodiments, the server 215 retrieves from the data store(s) 220 and/or data providers 225 values for the requested information component sets 150 that are specified for the matching entities in the desired information description 135. In some embodiments, the server 215 uses the maximum value 155 and the filtering parameter set 160 that the description 135 of some embodiments specifies for each requested information component set 150, in order to ascertain a maximum number of values to return and to filter undesirable values from the set of retrieved values.

In some embodiments, the server 215 gathers static data values for the requested information components sets from the data store(s) 220 and the data providers 225. Also, in some of these embodiments, the server 215 uses the data providers 225 to gather dynamically changing data values for the requested information component sets of the retrieved entities. In some embodiments, the dynamic data is also kept in the local data store(s) 220, while in other embodiments this data is only obtained through the data providers 225. Examples of such data providers include transit operators or third parties that provide dynamic transit data (e.g., transit vehicle schedules, transit vehicle real-time arrival/departure times, etc.), restaurant operators or third parties that provide dynamic restaurant data (e.g., data regarding daily specials or wait times), etc.

In some embodiments, the clients 205 execute a mapping application that displays numerous POIs on one or more maps. In some of these embodiments, the clients use the request protocol 120 to obtain information about the POIs from the server 215. Examples of such information includes addresses, photos, weather reports, reviews, etc., that are associated with the POIs. In some embodiments, the clients then display the obtained information in display areas that provide integrated views of different information related to the POIs.

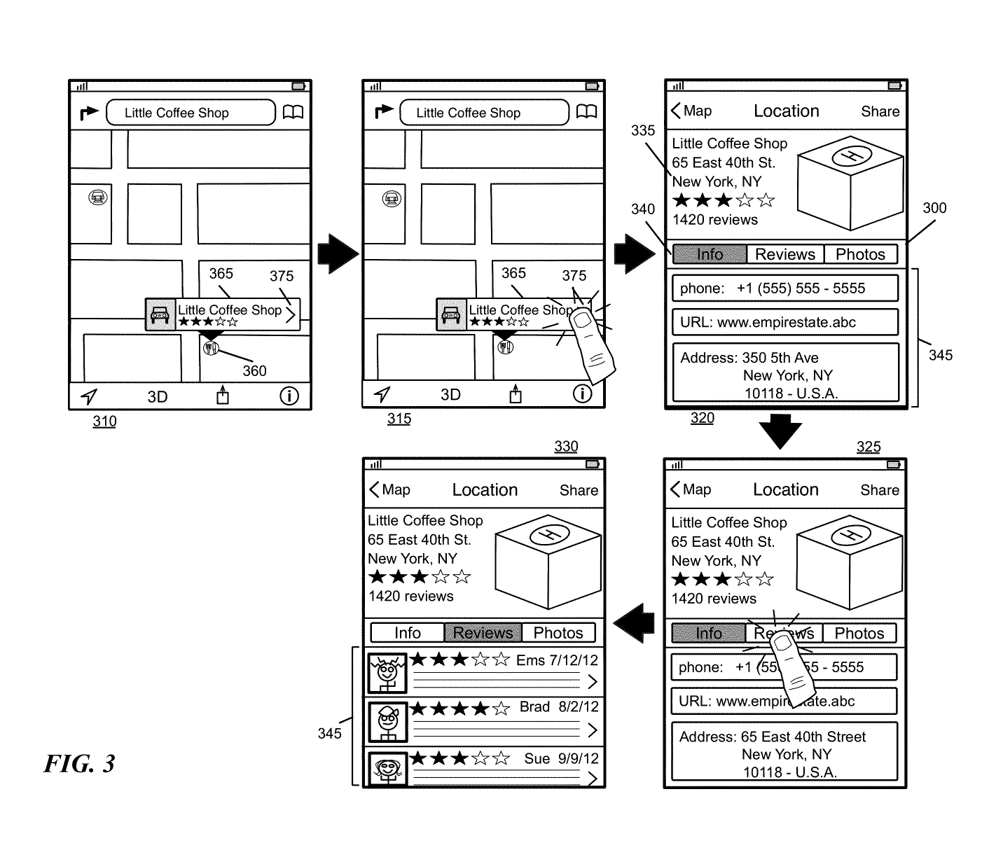

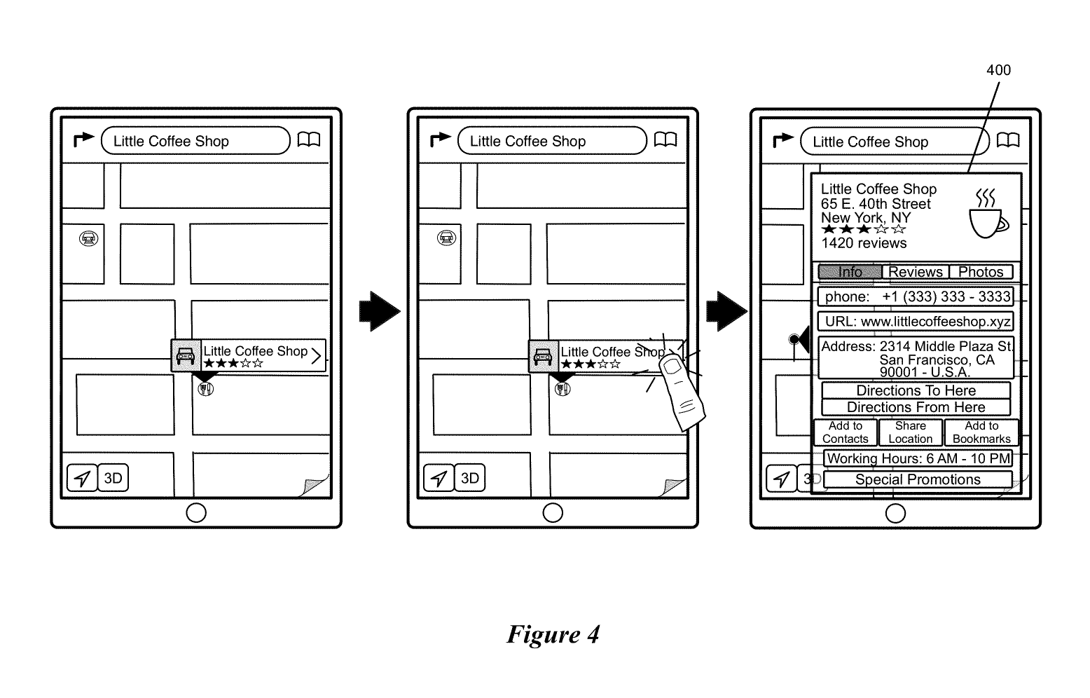

FIGS. 3 and 4 illustrate examples of two display areas that present integrated informational views for POIs on a map. The example in FIG. 3 is for a client smartphone device that executes a map application, while the example in FIG. 4 is for a client tablet device that executes a map application. In both of these examples, the display area 300 or 400 is presented after a user selects a banner that is presented near a POI after the POI has been selected. In the example illustrated in FIG. 3, the display area 300 encompasses the entire display that the client device presents upon the selection of the banner, while in the example illustrated in FIG. 4, the display area 400 is an overlay display that does not entirely overlap the map on which it is overlaid. The different approaches in FIGS. 3 and 4 in some embodiments are dictated by the smaller size of the phone screen in FIG. 3 than the tablet screen in FIG. 4.

FIG. 3 illustrates in five different operational stages 310-330 of the mapping application. In the first stage 310, the mapping application presents a banner 365 over a POI 360, which in this example is a Little Coffee Shop. The second stage 315 shows that a user selects an arrow 375 in the banner 365 to direct the mapping application to present the information display area 300 for displaying information about this POI. In some embodiments, the mapping application sends a request (according to the request protocol of some embodiments) to the server for data related to the Little Coffee Shop upon selection of the arrow 375, when the mapping application does not have this information or does not have up-to-date information about this coffee shop already. In other embodiments, the mapping application obtains the data for this POI and other POIs when it first presents a map of the region that contains this data. In still other embodiments, the mapping application obtains the information about the POIs when it downloads the map regions, but later (e.g., upon a request to view information about the POI) sends a request for this information in order to update its local copy of the information about the POI.

The third stage 320 shows this display area 300 after it has been presented. As shown in this figure, the display area 300 (referred to as an integrated informational view or place card below) includes a media display area 335, several tabs 340, and an information display area 345. The media display area 335 of some embodiments is for displaying different media content related to the POI, which in this example is the coffee shop. In some embodiments, the mapping application displays one photo, or a series of photos sequentially (e.g., a slideshow that utilizes the Ken Burns effect), in the media display area 335. The mapping application of some embodiments also overlays informational text on the media displayed in the media display area 335.

The tabs 340 are tabs for displaying different sets of entries grouped for different types of information associated with the different tabs. In some embodiments, the GUI 300 initially includes an “Info” tab, a “Reviews” tab, and a “Photos” tab as shown. When the info tab is selected, the mapping application displays in the information display area 345 entries related to general information about the POI. As shown, the general information about the POI includes a phone number, a URL for the POI, address, etc. This information is provided by the server 215 in its response to the client's request for information about the Local Coffee Shop.

The information display area 345 displays entries related to reviews when the reviews tab is selected. Such reviews are collected from data providers 225 (e.g., Yelp, Facebook, Twitter, etc.) and supplied to the mapping application as part of the server's response to a request for information about the Local Coffee Shop. The fourth stage 325 shows the user's selection of the review tab, while the fifth stage 330 shows the presentation of the reviews in the information display area 345.

When the photos tab is selected, the information display area 345 displays photos related to the Local Coffee Shop. These photos are collected from the local data store(s) 220 and/or data providers 225, and then supplied to the mapping application as part of the server's response to the client's request for information about the Local Coffee Shop.

The example illustrated in FIG. 4 is identical to the first three stages of the example illustrated in FIG. 3. One difference is that the information display area 400 (referred to as an integrated informational view or place card below) is an overlay display in FIG. 4 that does not completely block the map that was previously presented. As mentioned above, this is the case in some embodiments because the tablet display screen in FIG. 4 is larger than the smartphone display screen in FIG. 3. Also, because of this larger screen, the information display area in FIG. 4 is larger than the information display area in FIG. 3.

The request and response protocols of some embodiments is advantageous in that it allows a client to simply ask for the type of data that it wants and knows how to handle. When the server can provide more data but the client cannot handle this data (e.g., because it uses an older version of the mapping application that cannot process data defined for newer versions of mapping application), the server never provides this additional data to the client because the client never requests such data. Also, because the request and response protocols segment the requested information into different information component sets (different buckets), the server can gather different data from different sources and provide them in different information component sets to the client.

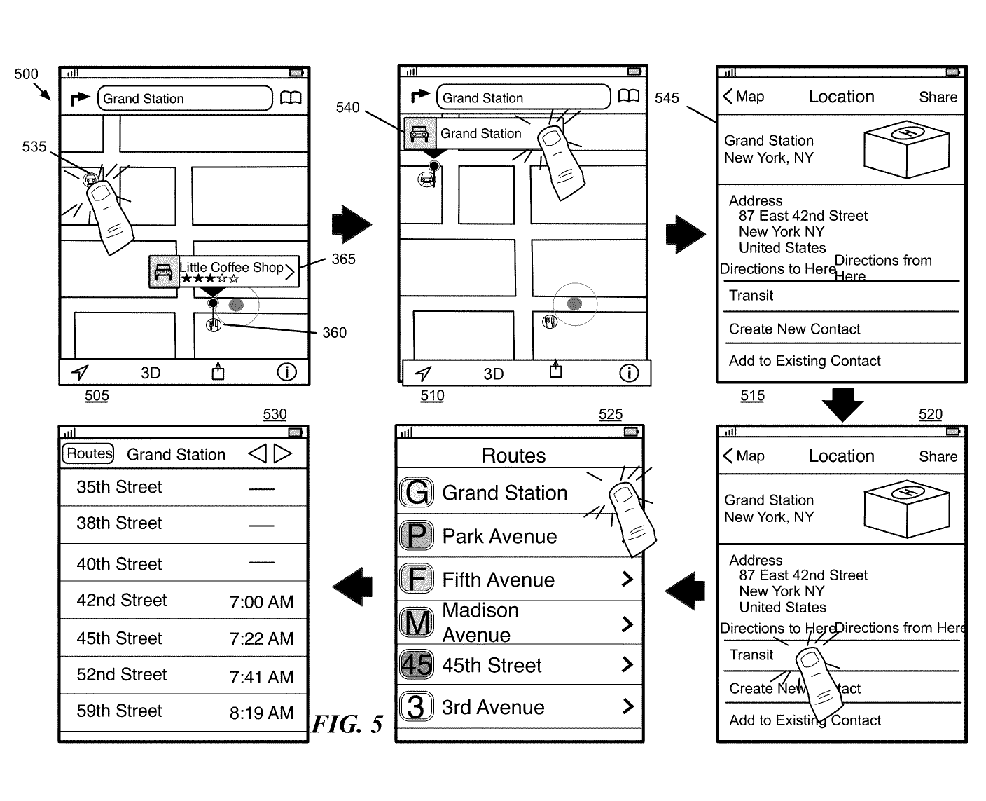

In some embodiments, the different data types that the server can provide are static data types and dynamic data types. FIG. 5 illustrates a map example that has two different POIs, one that in this example only needs static data types, and another that in this example needs both static and dynamic data types. In this example, the POI that only needs static data types is the Little Coffee Shop, while the POI that needs dynamic data types is the Grand Central Station.

The example in FIG. 5 is illustrated in six stages. The first stage 505 shows a portion of the map that has a banner 365 over the POI icon 360 for the Local Coffee Shop. This stage also shows the user selecting the POI icon 535 for the Grand Central Station. The second stage 510 shows the user selecting an affordance in the banner 540 for Grand Central Station, in order to direct the mapping application to open up the information display area 545 regarding this station. The third stage 515 shows this display area 545 after it has been presented.

The fourth stage 520 shows the user selecting a transit option 550 on the information display page, which results in a presentation of various transit routes 555 in the fifth stage 525. The transit data includes dynamic data gathered from the server, while other data on the information display page (e.g., address, etc.) includes static data. Examples of the dynamic transit data are vehicle transit times 560, which are shown in the sixth stage 530. As shown in FIG. 5, the user reaches the sixth stage 530, after being presented with different transit routes in the fifth stag 525.

The place card user interface (UI) of some embodiments is further described in U.S. patent application Ser. No. ______, entitled “A Mobile Device with Applications that Use a Common Place Card to Display Data Relating to a Location”, concurrently filed with this application with Attorney Docket No. APLE.P0621. This concurrently filed U.S. patent application Ser. No. ______ is incorporated herein by reference.

### II. Client Server Operations

In some embodiments, a client uses the request protocol of some embodiments to obtain information from a server about one or more data entities. The client in some embodiments may request the information to process a search request, to present a view of the information associated with a data entity (e.g., with a POI on a map), or to store such information so that it can later present this information or use it to process a search. In other embodiments, the client uses the request protocol for only a subset of these operations, while in still other, the client uses the request protocol for reasons other than those described above.

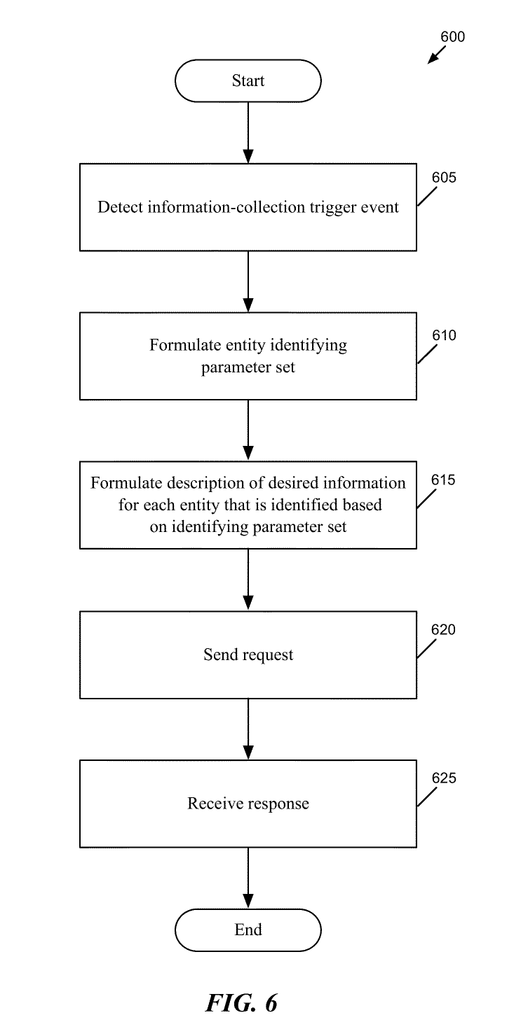

FIG. 6 illustrates a process 600 that a client device performs in some embodiments when it uses the request protocol of some embodiments. As shown in this figure, the process 600 starts when the client receives (at 605) an information-collection trigger event. The trigger event is different in different embodiments. In some embodiments, the trigger event can be a search request or a request to view information associated with a data entity (e.g., with a POI on a map). In these or other embodiments, the trigger even can be a request to download information about a portion of a map.

After 605, the process formulates (at 610) an entity identifying parameter set 130 for the server to use to identify one or more data entities that satisfy the information request from the client. As mentioned above, the entity ID parameter set 130 in some embodiments is expressed either as a set of search parameters 140 or as a list of entity identifiers 145. More specifically, in some embodiments, different requests can have different request types, and different request types having different ID parameter sets 130. For instance, in some embodiments, a search that is based on a lookup of a set of POI identifiers is specified in terms of a list of identifiers 145. Alternatively, a search for certain entities near a location is specified in some embodiments in terms of a lat/long coordinates (a latitude, a longitude) of a location, a radius about the location and a search string that describes the entities. Another example would be an address lookup that is specified in terms of a string that represents the address.

Next, at 615, the process formulates a description of the desired information that the server should retrieve for each entity that it identifies based on the entity identifying parameter set. As mentioned above, this description in some embodiments specifies (1) one or more information component sets 150 for each identified entity, and (2) for each specified information component set, (i) maximum number 155 of values to gather, and (ii) a set of filtering parameters 160 to filter out undesirable values from the gathered number of values.

At 620, the process then sends to the server the request, which includes the formulated entity identifying parameter set and the formulated desired-information description. Next, at 625, the process receives the server's response. At 625, the process 600 in some embodiments formulates a presentation of the response.

In some embodiment, the process' formulation (at 625) of the presentation of the response is dynamic and is dependent on the data that is returned by the server, For instance, in some embodiments, the response protocol includes a UI presentation component that allows the server to tell the client the best order to display the returned information, and to give it a hint that certain information should be highlighted or made more prominent. Specifically, in some embodiments, the UI presentation component includes an ordered list of component types, plus one type as the “highlighted” component. For example, the server's response might include the following information component sets: Entity, Address, Reviews, Ratings, Photos, UI Presentation and Movie Times. The UI presentation component of the response in this example might contain the ordering “Entity, Address, Photos, Ratings, Movie Times” with the emphasized value “Movie Times.” The client would then display the returned component values in that order, and put highlighting around “Movie Times”.

As mentioned above, some embodiments of the invention are used by a mapping application that uses the request protocol of these embodiments to gather information about POIs on a map and to present display areas (e.g., place cards 300 or 400 of FIGS. 3 and 4) that presented integrated informational views related to the POIs. For some of these embodiments, the server provides a value that describes the type of the returned place card (e.g., place cards from a set of geographic ontology types; e.g. “Restaurant”, “Church”, etc.) that the client should use to present the data values in the response. The client can then use this returned place card value to select the correct place card for presenting the integrated informational view for a POI.

One of ordinary skill will realize that the above-described approaches only provide a few ways for making the formulation of the presentation of the response dynamic. Other embodiments may use other techniques to dynamically generate the presentation of the data. For instance, some embodiments select a place card template from several place card template types based on the collection of information component sets for which the server returned a non-null value. Specifically, in these embodiments, the client first identifies the information component sets for which the server returned non-null values, and then based on these information component sets selects a place card template that is designed to best suited for presenting an integrated view of these information component sets.

After 625, the process ends.

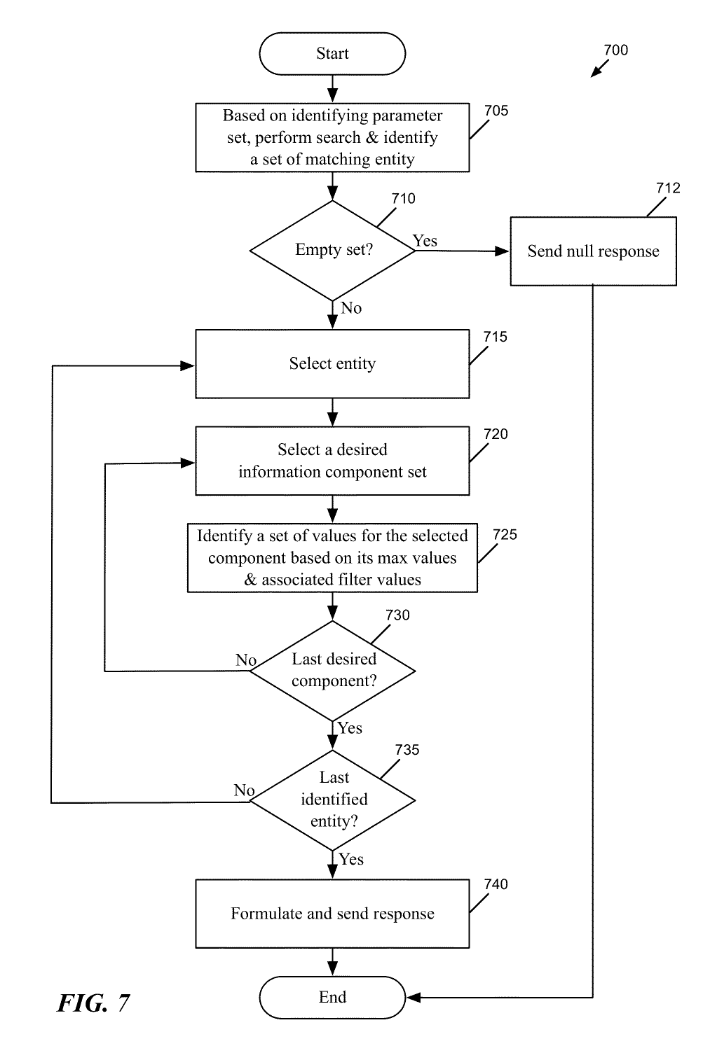

FIG. 7 illustrates a process 700 that a server performs to process a request from a client. As mentioned above, the server is one physical machine in some embodiments, while it is multiple servers executing on one or more physical machines in other embodiments. As shown in FIG. 7, the process 700 initially identifies (at 705) a set of one or more data entities based on the identifying parameter set in the request from the client. In some embodiment, each entity in the set of identified data entities has a set of attributes that match the supplied identifying parameter set. For instance, when the identifying parameter set provides an identifier for a specific POI, the identified data entity is the POI that has an identifier that matches the provided identifier. Alternatively, when the request is a search for a particular data entity (e.g., a coffee shop) in a particular location (e.g., in a San Francisco locality), then the identified entities in some embodiments are entities associated with the search string “coffee shop” and/or a search string derived from “coffee shop” in the specified San Francisco locality. When the identified set of entities includes too many entities, the process 700 filters out some of the identified entities in some embodiments. To identify such entities, the server in some embodiments only examines its own local data stores, while in other embodiments it also interacts with one or more external data providers 225.

At 710, the process determines whether the set of identified data entities is an empty set. If so, the process returns an empty set and ends. Otherwise, the process selects (at 715) one of the identified entities. For the selected entity, the process then identifies (at 720) an information component set that the client specified in its request. At 725, the process gathers one or more values for this information components set and then filters the gathered values based on the filter parameter and maximum number specified for this information component set in the request from the client. As mentioned above, the maximum value and the filtering parameter set that the desired-info description in the client request specifies for each requested information component set 150 a maximum number of values to return and filter parameters to use to fitter undesirable values from the set of retrieved values.

To gather the values for the requested information component sets, the server in some embodiments only examines its own local data stores, while in other embodiments it also interacts with one or more external data providers 225. In still other embodiments, the server only obtains the values for the requested information component sets from external data providers. In some embodiments, the server interacts with the external data providers to obtain dynamically changing data relating to the identified entities.

After 725, the process determines (at 730) whether it has gathered data values for the last requested information component set for the entity selected at 715. If not, it returns to 720 to select another information component set and repeat 725 to gather data values for this newly selected information component set. If so, the process then determines (at 735) whether it has examined all of the entities identified at 705. If it has not, it returns to 715 to select another entity and iteratively repeat operations 720 and 725 to gather data values for all of the information components sets of the newly selected entity. Otherwise, the process transition from 735 to 740, where it uses the gathered data values to formulate the response to the client.

As mentioned above, the formulated response from the server includes (1) a set of entities that were identified based on the entity identifying parameter set, and (2) for each entity in the set of entities, a list of responses that includes one or more values for each information component set that the client requested for the identified entities. The server in some embodiments may return a null value (or ‘not found’ value or an empty set) for an information component set. Also, in some embodiments, the response protocol also includes a UI presentation component that allows the server to tell the client the best order to display the returned information, and to give it a hint that certain information should be highlighted or made more prominent. In some embodiment, the UI presentation component is one of the information component sets returned by the server.

After 740, the process 700 ends.

### III. Example Requests and Responses

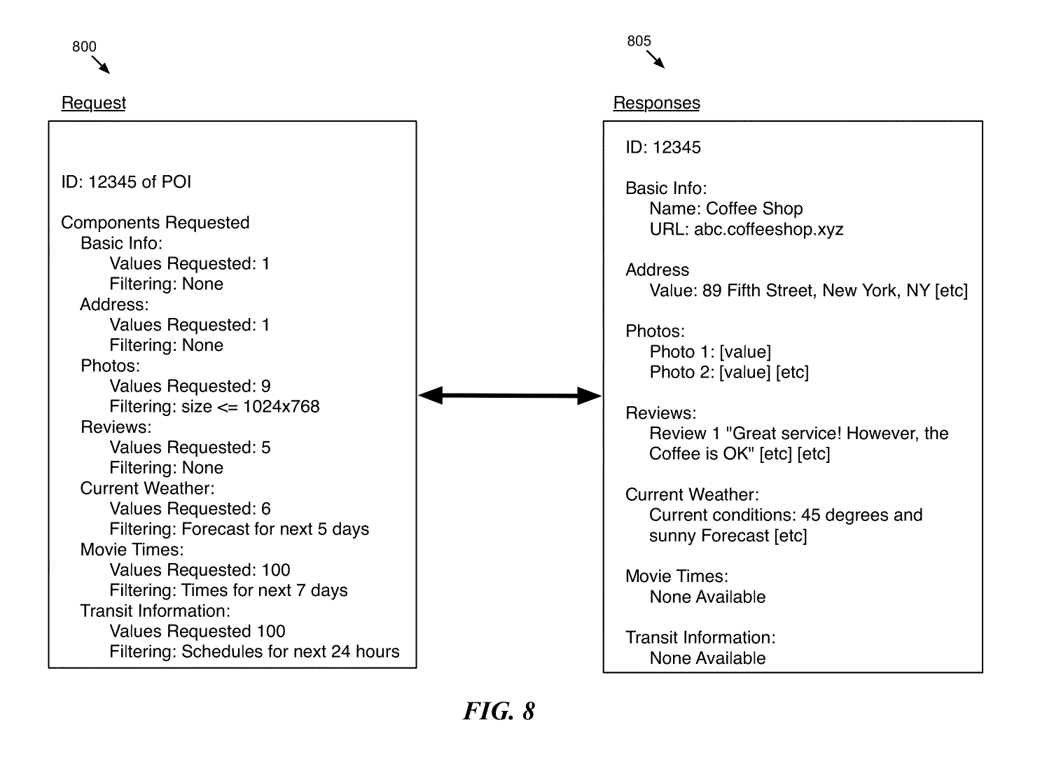

FIGS. 8-10 illustrate several examples of requests and responses according to the protocol of some embodiments of the invention. Each of these examples relates to a request that a mapping application makes in some embodiments to obtain information about a POI or a search of a locality. FIG. 8 illustrates (1) a request 800 that the mapping application sends to the server for information associated with a POI, which is identified by the mapping application and the server with an identifier 12345, and (2) a response 805 that the server provides in reply to the request 800.

In this example, this POI is a coffee shop called the Little Coffee Shop. The request includes the identifier 12345 as its entity identifying parameter set. The request also includes the following information components sets: Basic Info, Address, Photos, Reviews, Current Weather, Movie Times, and Transit Information. To gather data values for these information component sets, the server has data stored in its local storage for some of these information component sets (e.g., the name, address, etc.) but it has to gather data dynamically for other information component sets (e.g., current weather, reviews, etc.) from one or more data services (e.g., third party data providers).

For two of the information sets, Movie Times and Transit Information, the server provides null values. Clearly, a coffee shop would not have any associated movie-time values, but the mapping application is not aware of this, nor is it aware of whether the server has data values for any of the other information sets that it requests. The mapping application simply asks for the information sets. If it receives a value for an information set, the mapping application will display it. Otherwise, it will display no value for a requested information set (e.g., for the Movie Times associated with the Little Coffee Shop). It should be noted that the response 805 also includes the identifier 12345, which identifies the response as a response that is associated with the Little Coffee Shop.

As shown in FIG. 8, the request includes a number of values requested, which are 1, 1, 9, 5, 6, 100, and 100 respectively for the information component sets Basic Info, Address, Photos, Reviews, Current Weather, Movie Times, and Transit Information. Also, as shown, the request includes non-null filter parameter sets for Photos, Reviews, Current Weather, Movie Times, and Transit Information. The filter value for Photos specifies a maximum resolution (i.e., 1024×768) for the returned photos. This filter value combined with the 9 photos that are requested by the number of values requested. for the Photos) directs the server to search and provide 9 photos that are associated with the Little Coffee Shop and that are smaller than the maximum resolution. Similarly, given that the Current Weather information set has a max number of 6 and a fitter parameter set that specifies 5 days, the server will provide the current weather at the locality of the coffee shop along with the weather at that location for the next 5 days.

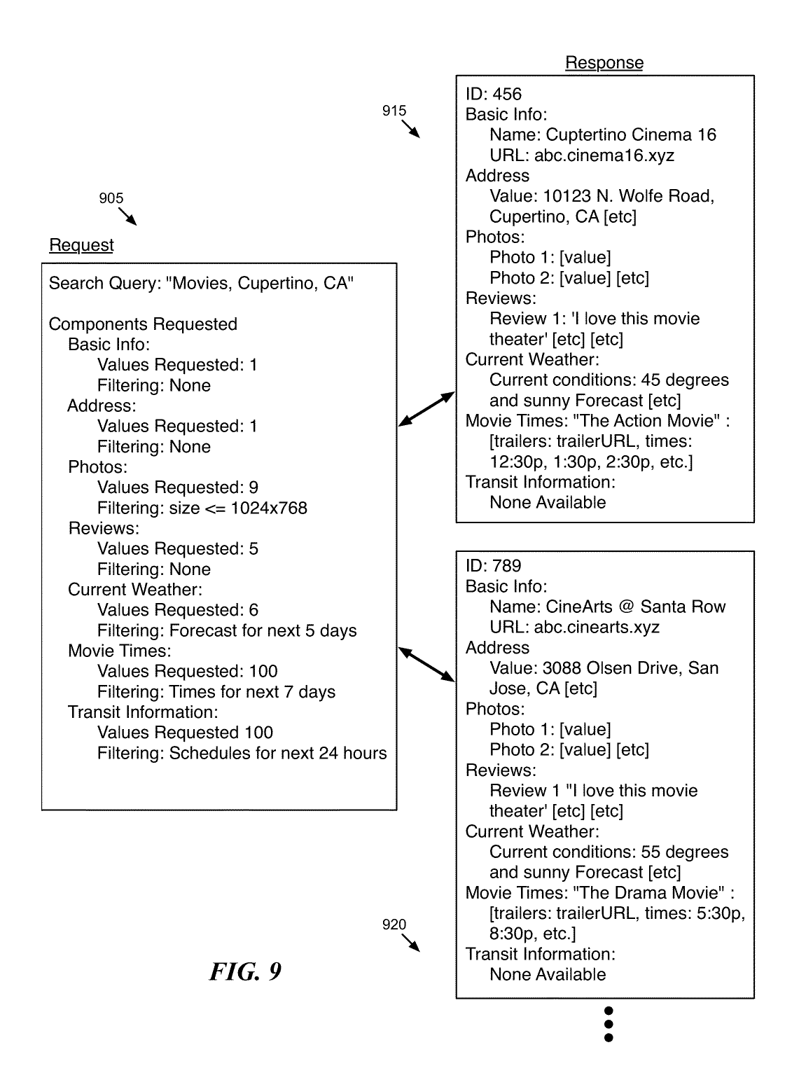

FIG. 9 illustrates another example of a request-response exchange between the mapping application and the server. In this example, the mapping application is trying to collect information about movies that are shown in Cupertino, Calif. In some embodiments, the mapping application sends its request 905 when a user enters a search string “Movies” while viewing a map of Cupertino, or enters a search string “Movies Cupertino California.” Given the search aspect of the request, the entity identifying parameter set of the request includes a search query that specifies the following string: Movies, Cupertino, Calif.

Based on this search string, the server in some embodiments queries its local data store and/or one or more data services to identify multiple movie theaters in, and in some cases near, Cupertino Calif. For each identified movie theater, the server collects data values for the information component sets that are specified in the request by examining its local data store and interacting with one or more data services. The information component sets in this example include Basic Info, Address, Photos, Reviews, Current Weather, Movie Times and Transit Information. The server collects the data for the information component sets based on the maximum number value and filter parameter set of the information component sets.

For each identified movie theater, the server specifies one structure that identifies the movie theater and the information component data that it collected for the movie theater. The server's response includes each of these structures. FIG. 9 illustrates responses that include two structures 915 and 920 for two movie theaters in Cupertino. The theater's structure 915 or 920 includes an identifier that serves as the theater's POI identifier for the map application. Each theater structure also includes the data values gathered for the theater, which in this example includes Basic Info, Address, Photos, Reviews, Current Weather, and Movie Times. Like the example illustrated in FIG. 8, the responses 915 and 920 in FIG. 9 do not include any values for the Transit information set.

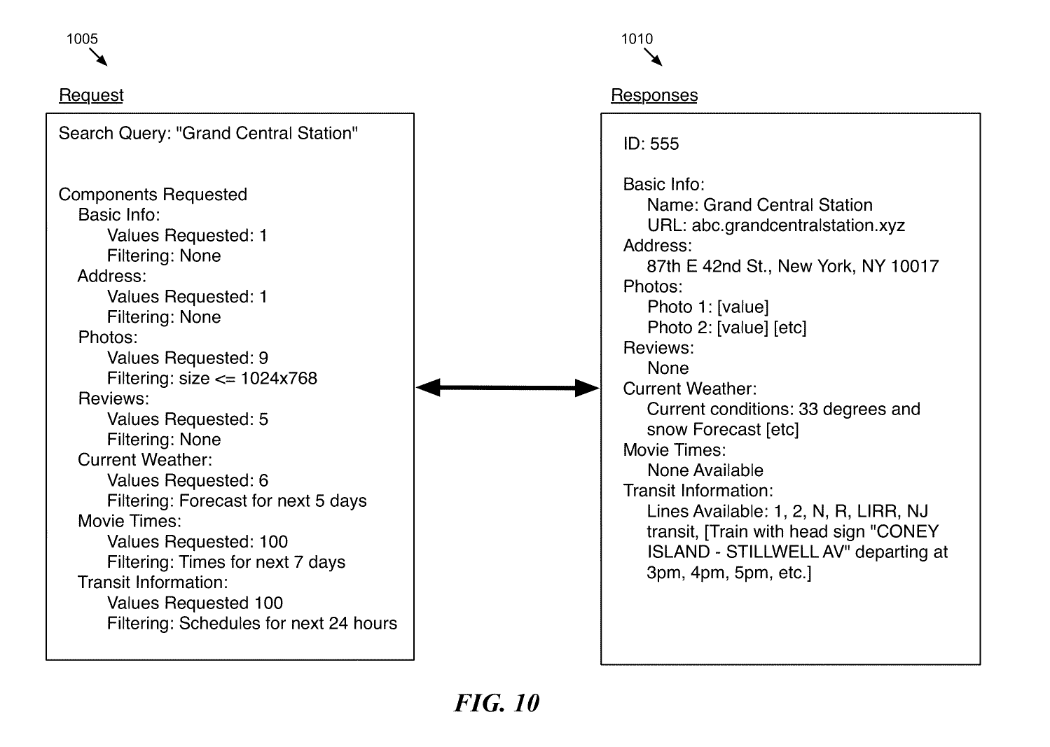

FIG. 10 illustrates another example of a request-response exchange between the mapping application and the server. In this example, the mapping application is trying to collect information about Grand Central Station. In some embodiments, the mapping application sends its request 1005 when a user enters a search string “Grand Central Station.” Given the search aspect of the request, the entity identifying parameter set of the request includes a search query that specifies the following string: Grand Central Station.

Based on this search string, the server in some embodiments queries its local data store and/or one or more data services to identify entities that best match the search string “Grand Central Station.” In doing its search, the server will identify Grand Central Station in NY as the POI associated with the search string. For this station, the server then collects data values for the information component sets that are specified in the request by examining its local data store and interacting with one or more data services. The information component sets in this example include Basic Info, Address, Photos, Reviews, Current Weather, Movie Times and Transit Information. The server collects the data for the information component sets based on the maximum number value and filter parameter set of the information component sets.

The server then packages all the data values into one response 1010 and provides this response to the mapping application. As shown in FIG. 10, the response 1010 includes an identifier that serves as the POI identifier for Grand Central Station. The response also includes non-null values for the following information component sets: Basic Info, Address, Photos, Current Weather, and Transit Information. Here, the transit information includes 100 values related the train schedules for the next 24 hours, which is what was specified in the request 1005. In this example, the response 1010 has null values for the requested Reviews and Movie Times.

### IV. Electronic Device

Many of the above-described features and applications are implemented as software processes that are specified as a set of instructions recorded on a computer or machine readable storage medium (also referred to as computer or machine readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

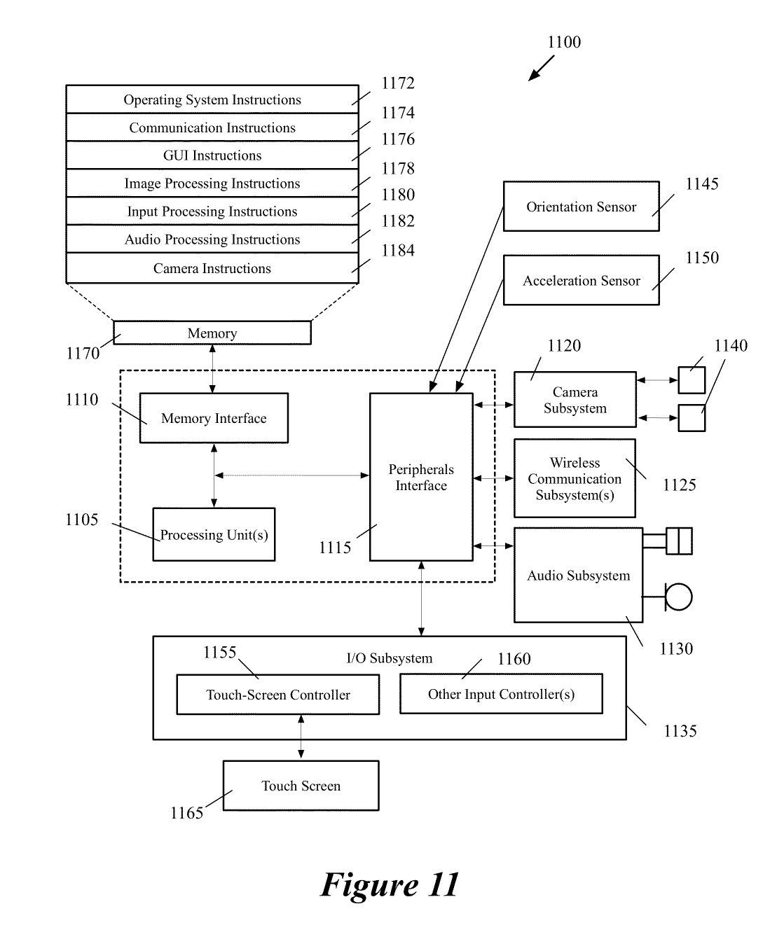

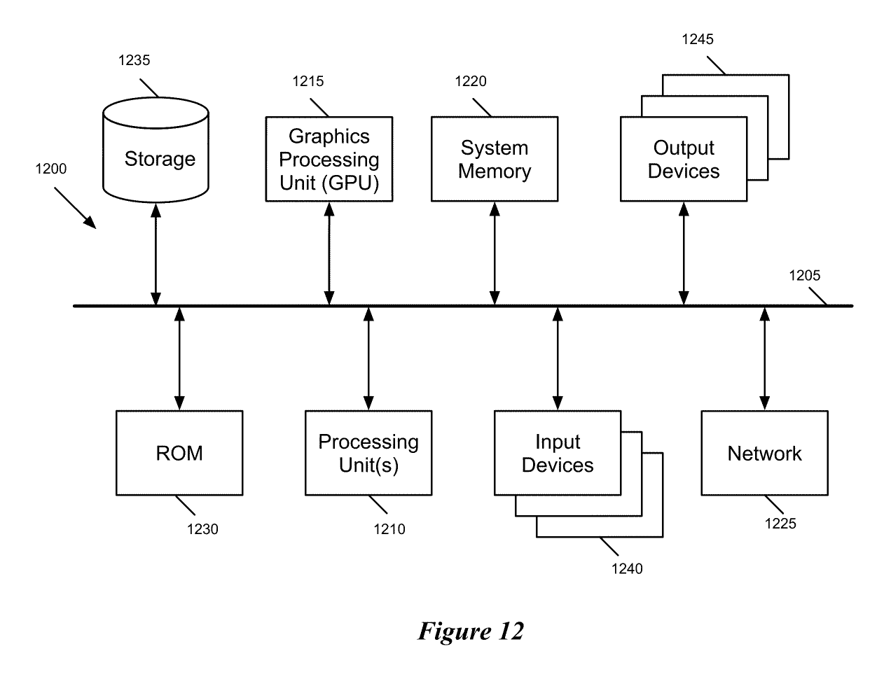

The processes described above execute in some embodiments on mobile devices (e.g., smartphones (e.g., iPhones®) and tablets (e.g., iPads®)) or computers (e.g., laptops, desktops, servers, etc.). For some embodiments of the invention, FIG. 11 illustrates an example of an architecture 1100 of a mobile device, while FIG. 12 illustrates an example of an architecture 1200 of a computer. Examples of mobile computing devices include smartphones, tablets, laptops, etc. As shown, the mobile computing device 1100 includes one or more processing units 1105, a memory interface 1110 and a peripherals interface 1115.

The peripherals interface 1115 is coupled to various sensors and subsystems, including a camera subsystem 1120, a wireless communication subsystem(s) 1125, an audio subsystem 1130, an I/O subsystem 1135, etc. The peripherals interface 1115 enables communication between the processing units 1105 and various peripherals. For example, an orientation sensor 1145 (e.g., a gyroscope) and an acceleration sensor 1150 (e.g., an accelerometer) is coupled to the peripherals interface 1115 to facilitate orientation and acceleration functions.

The camera subsystem 1120 is coupled to one or more optical sensors 1140 (e.g., a charged coupled device (CCD) optical sensor, a complementary metal-oxide-semiconductor (CMOS) optical sensor, etc.). The camera subsystem 1120 coupled with the optical sensors 1140 facilitates camera functions, such as image and/or video data capturing. The wireless communication subsystem 1125 serves to facilitate communication functions. In some embodiments, the wireless communication subsystem 1125 includes radio frequency receivers and transmitters, and optical receivers and transmitters (not shown in FIG. 11). These receivers and transmitters of some embodiments are implemented to operate over one or more communication networks such as a GSM network, a Wi-Fi network, a Bluetooth network, etc. The audio subsystem 1130 is coupled to a speaker to output audio (e.g., to output voice navigation instructions). Additionally, the audio subsystem 1130 is coupled to a microphone to facilitate voice-enabled functions, such as voice recognition (e.g., for searching), digital recording, etc. Conjunctively, or alternatively, some embodiments also include a wired communication subsystem to facilitate communication functions with a vehicle's electronic system.

The I/O subsystem 1135 involves the transfer between input/output peripheral devices, such as a display, a touch screen, etc., and the data bus of the processing units 1105 through the peripherals interface 1115. The I/O subsystem 1135 includes a touch-screen controller 1155 and other input controllers 1160 to facilitate the transfer between input/output peripheral devices and the data bus of the processing units 1105. As shown, the touch-screen controller 1155 is coupled to a touch screen 1165. The touch-screen controller 1155 detects contact and movement on the touch screen 1165 using any of multiple touch sensitivity technologies. The other input controllers 1160 are coupled to other input/control devices, such as one or more buttons. Some embodiments include a near-touch sensitive screen and a corresponding controller that can detect near-touch interactions instead of or in addition to touch interactions.

The memory interface 1110 is coupled to memory 1170. In some embodiments, the memory 1170 includes volatile memory (e.g., high-speed random access memory), non-volatile memory (e.g., flash memory), a combination of volatile and non-volatile memory, and/or any other type of memory. As illustrated in FIG. 11, the memory 1170 stores an operating system (OS) 1172. The OS 1172 includes instructions for handling basic system services and for performing hardware dependent tasks.

The memory 1170 also includes communication instructions 1174 to facilitate communicating with one or more additional devices; graphical user interface instructions 1176 to facilitate graphic user interface processing; image processing instructions 1178 to facilitate image-related processing and functions; input processing instructions 1180 to facilitate input-related (e.g., touch input) processes and functions; audio processing instructions 1182 to facilitate audio-related processes and functions; and camera instructions 1184 to facilitate camera-related processes and functions. The instructions described above are merely exemplary and the memory 1170 includes additional and/or other instructions in some embodiments. For instance, the memory for a smartphone may include phone instructions to facilitate phone-related processes and functions. Additionally, the memory may include instructions for a mapping and navigation application as well as other applications. The above-identified instructions need not be implemented as separate software programs or modules. Various functions of the mobile computing device can be implemented in hardware and/or in software, including in one or more signal processing and/or application specific integrated circuits.

While the components illustrated in FIG. 11 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 11 may be split into two or more integrated circuits.

FIG. 12 conceptually illustrates an electronic system 1200 with which some embodiments of the invention are implemented. The electronic system 1200 can be a client device or a server device described above. The electronic system 1200 may be a computer (e.g., a desktop computer, personal computer, tablet computer, server computer, mainframe, a blade computer etc.), or any other sort of electronic device. Such an electronic system includes various types of computer readable media and interfaces for various other types of computer readable media. Electronic system 1200 includes a bus 1205, processing unit(s) 1210, a system memory 1225, a read-only memory 1230, a permanent storage device 1235, input devices 1240, and output devices 1245.

The bus 1205 collectively represents all system, peripheral, and chipset buses that communicatively connect the numerous internal devices of the electronic system 1200. For instance, the bus 1205 communicatively connects the processing unit(s) 1210 with the read-only memory 1230, the system memory 1225, and the permanent storage device 1235.

From these various memory units, the processing unit(s) 1210 retrieve instructions to execute and data to process in order to execute the processes of the invention. The processing unit(s) may be a single processor or a multi-core processor in different embodiments.

The read-only-memory (ROM) 1230 stores static data and instructions that are needed by the processing unit(s) 1210 and other modules of the electronic system. The permanent storage device 1235, on the other hand, is a read-and-write memory device. This device is a non-volatile memory unit that stores instructions and data even when the electronic system 1200 is off. Some embodiments of the invention use a mass-storage device (such as a magnetic or optical disk and its corresponding disk drive) as the permanent storage device 1235.

Other embodiments use a removable storage device (such as a floppy disk, flash drive, etc.) as the permanent storage device. Like the permanent storage device 1235, the system memory 1225 is a read-and-write memory device. However, unlike storage device 1235, the system memory is a volatile read-and-write memory, such a random access memory. The system memory stores some of the instructions and data that the processor needs at runtime. In some embodiments, the invention's processes are stored in the system memory 1225, the permanent storage device 1235, and/or the read-only memory 1230. From these various memory units, the processing unit(s) 1210 retrieve instructions to execute and data to process in order to execute the processes of some embodiments.

The bus 1205 also connects to the input and output devices 1240 and 1245. The input devices enable the user to communicate information and select commands to the electronic system. The input devices 1240 include alphanumeric keyboards and pointing devices (also called “cursor control devices”). The output devices 1245 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 12, bus 1205 also couples electronic system 1200 to a network 1265 through a network adapter (not shown). In this manner, the computer can be a part of a network of computers (such as a local area network (“LAN”), a wide area network (“WAN”), or an Intranet, or a network of networks, such as the Internet. Any or all components of electronic system 1200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such machine-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The machine-readable media may store a program that is executable by at least one processing unit and includes sets of instructions for performing various operations. Examples of programs or code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs), customized ASICs or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, many of the figures illustrate various touch gestures (e.g., taps, double taps, swipe gestures, press and hold gestures, etc.). However, many of the illustrated operations could be performed via different touch gestures (e.g., a swipe instead of a tap, etc.) or by non-touch input (e.g., using a cursor controller, a keyboard, a touchpad/trackpad, a near-touch sensitive screen, etc.). Also, several examples mentioned above use the protocol of some embodiments to obtain information about POIs on a map. One of ordinary skill will realize that the invention's protocol is used to fetch information about data entities that are not tied to a specific location on a map, e.g., about a particular company, Thus, one of ordinary skill in the art would understand that the invention is not to be limited by the foregoing illustrative details, but rather is to be defined by the appended claims.

What is claimed is:

1. A method of requesting information, the method comprising:
specifying an entity identifying parameter set for a set of servers to use to identify at least one data entity;
specifying a description of desired information that the set of servers should gather for any data entity that is identified; and
sending the entity identifying parameter set and the desired-information description in one request to the set of servers.

2. The method of claim 1, wherein the entity identifying parameter set includes an identifier associated with the data entity.

3. The method of claim 1, wherein the entity identifying parameter set includes a search parameter set that includes at least one parameter for the set of servers to use to identify the data entity.

4. The method of claim 1, wherein the desired-information description includes a plurality of requested information component sets, each information component set specifying one type of data value that is associated with the identified data entity.

5. The method of claim 4, wherein the desired-information description further includes a filter parameter set for at least each of a plurality of the information component sets, each filter parameter set for the server to use to filter the set of data values that the server identifies for the filter parameter set's associated information component set.

6. The method of claim 4 further comprising:
receiving a response that comprises a list of data entities that were identified based on the entity identifying parameter set, and a list of responses for each identified entity in the list of data entities,
wherein the list of responses for each identified entity comprises a set of values for each information component set specified in the desired-information description for the identified entity.

7. The method of claim 6, wherein the set of values for at least one information component set is null, while the set of values for at least one other information component set is not null.

8. The method of claim 1 further comprising receiving a response that comprises a list of data entities that were identified based on the entity identifying parameter set, and a list of responses for each identified entity in the list of data entities.

9. A non-transitory machine readable medium storing a program for requesting information, the program comprising sets of instructions for:
specifying an entity identifying parameter set for a set of servers to use to identify at least one data entity;
specifying a description of desired information that the set of servers should gather for any data entity that is identified; and
sending the entity identifying parameter set and the desired-information description in one request to the set of servers.

10. The non-transitory machine readable medium of claim 9, wherein the entity identifying parameter set includes an identifier associated with the data entity or a search parameter set comprising at least one parameter for the set of servers to use to identify the data entity.

11. The non-transitory machine readable medium of claim 9,
wherein the desired-information description includes a first plurality of requested information component sets, a filter parameter set for at least each of a second plurality of the information component sets, and a maximum number of values to return for at least each of a third plurality of the information component sets;
each information component set specifying one type of data value that is associated with the identified data entity;
each filter parameter set for the server to use to filter the set of data values that the server identifies for the filter parameter set's associated information component set; and
each maximum number of values for the server to use to identifying the number of values to return for the information component set associated with the maximum number.

12. The non-transitory machine readable medium of claim 11,
wherein the program further comprises a set of instructions for receiving a response that comprises a list of data entities that were identified based on the entity identifying parameter set, and a list of responses for each identified entity in the list of data entities;
wherein the list of responses for each identified entity comprises a set of values for each information component set specified in the desired-information description for the identified entity.

13. The non-transitory machine readable medium of claim 1, wherein the program further comprises a set of instructions for receiving a response that comprises a list of data entities that were identified based on the entity identifying parameter set, and a list of responses for each identified entity in the list of data entities.

14. A method of processing a request for information, the method comprising:
receiving a request comprising an entity identifying parameter set for use in identifying a set of entities, and a description of desired information for use to identifying the information to gather for the identified set of entities;
using the entity identifying parameter set to identify the set of entities;
using the desired-information description to gathered one or more sets of data values for each entity in the identified set of entities;
providing a response comprising the identified set of entities and the gathered sets of data values.

15. The method of claim 14, wherein the entity identifying parameter set includes an identifier associated with a particular data entity, wherein using the entity identifying parameter set comprises using the identifier to identify the particular data entity.

16. The method of claim 14, wherein the entity identifying parameter set includes a search parameter, wherein using the entity identifying parameter set comprises using the search parameter to perform a search to identify one or more entities that have an association with the search parameter.

17. The method of claim 14, wherein the desired-information description includes a first plurality of requested information component sets, a filter parameter set for at least each of a second plurality of the information component sets, the method further comprising:
gathering a set of data values for each of the first plurality of information component sets;
for each information component set that has an associated filter parameter set, using the filter parameter set to filter the set of gathered data values for the information component set to remove any data value that is not desired.

18. The method of claim 17, wherein the set of gathered data values for at least one information component set is an empty set.

19. The method of claim 14, wherein the desired-information description includes a first plurality of requested information component sets, a maximum number of values for at least each of a second plurality of the information component sets, the method further comprising:
gathering data values for each of the first plurality of information component sets;
for each information component set that has an associated maximum number of values, using the maximum number to limit the number of gathered data values for the information component set.

20. The method of claim 14, wherein the desired-information description includes a plurality of requested information component sets, the method further comprising specifying in the response an ordered list of component types that defines the ordering of the component sets in a user interface (UI) display area.

21. The method of claim 21 further comprising specifying in the response at least component type as a highlight component or a particular component that should be featured more prominently than each other component type in the UI display area.

22. The method of claim 21 further comprising specifying in the response at least one value that specifies a geographic ontology type that is used to present the component sets in the UI display area.
